(19) United States
(12) Patent Application Publication
(10) Pub. No.: US 2026/0037856 A1
(43) Pub. Date: Feb. 5, 2026

(54) CONFORMAL-BASED MACHINE UNLEARNING AND ADAPTIVE DECOMPOSITION

(71) Applicants: John Flume, La Marque, TX (US); Kailash Talreja, Mumbai (IN); Saurabh Jha, Austin, TX (US)

(72) Inventors: John Flume, La Marque, TX (US); Kailash Talreja, Mumbai (IN); Saurabh Jha, Austin, TX (US)

(21) Appl. No.: 18/790,096

(22) Filed: Jul. 31, 2024

(51) Int. Cl. G06N 20/00

(52) U.S. Cl. CPC G06N 20/00

(57) ABSTRACT

A method for removing data from a model includes identifying removal data for removal from the model, where the model includes sub-models. The method also includes identifying a sub-model from the sub-models associated with the removal data, where the sub-model includes conformal predictors. Further, the method includes performing a data exclusion action on the sub-model to obtain a modified sub-model and making a determination that the modified sub-model is above a threshold accuracy based on a reevaluation using a first validation data set. In addition, the method includes calibrating, based on the determination, the conformal predictors of the modified sub-model to obtain calibrated conformal predictors. Moreover, the method includes validating the calibrated conformal predictors using a second validation data set and reintegrating, based on the validating, the modified sub-model into the model.

### BACKGROUND

Models based on machine learning use large datasets for training purposes. From time-to-time some data contained within these datasets may need to be removed from the models. In other words, the influence that the data provided to the model through the training may need to be undone.

### BRIEF DESCRIPTION OF DRAWINGS

Certain embodiments of the disclosure will be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments.

FIG. 2 shows a diagram of a support system in accordance with one or more embodiments.

FIG. 3 shows a flowchart of a method for training a model and responding to a user input using the model in accordance with one or more embodiments.

FIG. 4 shows a flowchart of a method for automatically updating a model over time in accordance with one or more embodiments.

FIG. 5 shows a flowchart of a method for automatically removing data from a model in accordance with one or more embodiments.

FIG. 6 shows a computing system in accordance with one or more embodiments.

### DETAILED DESCRIPTION

In the below description, numerous details are set forth as examples of embodiments described herein. It will be understood by those skilled in the art, and having the benefit of this Detailed Description, that one or more embodiments of embodiments described herein may be practiced without these specific details and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

The field of machine learning is currently facing critical challenges related to data privacy and model reliability. Current practices for data removal from machine learning models, necessitated by privacy laws or data corrections, are inefficient and often require complete model retraining. This process is not only resource-intensive but also reduces the consistency and trustworthiness of model outputs. In addition, different jurisdictions have vastly different legal requirements, which may also be contradictory, thereby causing adherence to such legal requirements to be an arduous task. In addition, erasure of personal data or reducing the amount of training data may compromise the performance of the model.

Traditional methods for modifying machine learning models to exclude specific data points are inefficient, leading to significant computational overhead and potential lapses in regulatory compliance. The removal of data can inadvertently affect the model's predictive accuracy, leading to a loss of confidence in its results. This presents a substantial hurdle, as models must be both flexible to changes and steadfast in their predictive capabilities to be of practical use in various applications.

To address, at least in part, the aforementioned issues discussed above, embodiments disclosed herein relate to systems, methods, and/or non-transitory computer readable mediums that enables an approach for unlearning processes in machine learning models. By employing a conformal-based sub-model selection technique, the solution strategically decomposes models into subunits, each tailored to the reliability of the data they contain, as assessed by conformal prediction methods. This allows for precise and targeted data removal. Complementing this, an adaptive decomposition process dynamically reconfigures the model in response to data alterations, guided by real-time feedback from conformal prediction intervals. These techniques collectively ensure that the model's integrity and predictive accuracy are maintained post-modification.

Embodiments described herein provide a framework that addresses the need for efficient data removal and while maintaining model reliability. It provides computational efficiency by eliminating the need for complete model retraining, maintains model reliability through guided unlearning, and ensures compliance with data privacy regulations.

The following describes one or more embodiments.

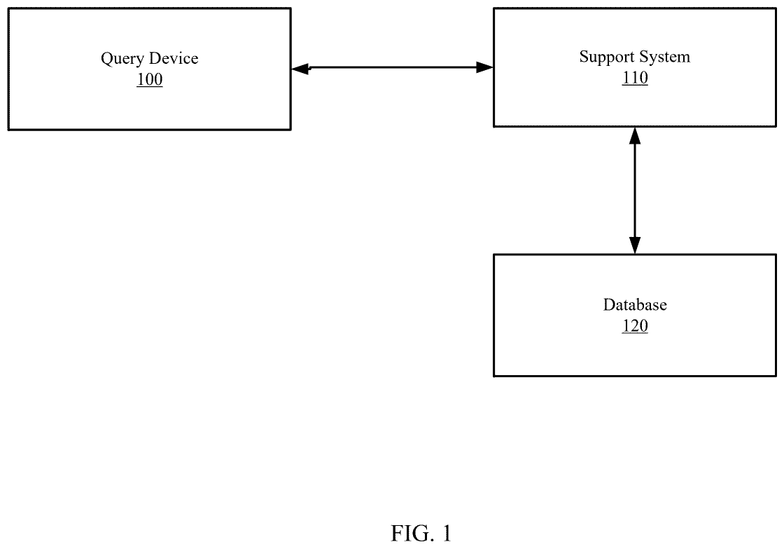

FIG. 1 shows a system in accordance with one or more embodiments. The system may include a query device (100) a support system (110), and a database (120). Each of these system components is described below.

In one or more embodiments, the query device (100), the support system (110), and/or the database (120) may operatively connect to one another through a network (not shown) (e.g., a local area network (LAN), a wide area network (WAN) such as the Internet, a mobile network, any other network type, or a combination thereof). The network may be implemented using any combination of wired and/or wireless connections. Further, the network may encompass various interconnected, network-enabled subcomponents (or systems) (e.g., switches, routers, gateways, etc.) that may facilitate communications between the query device (100), the support system (110), and the database (120). Moreover, the query device (100), the support system (110), and the database (120) may communicate with one another using any combination of wired and/or wireless communication protocols.

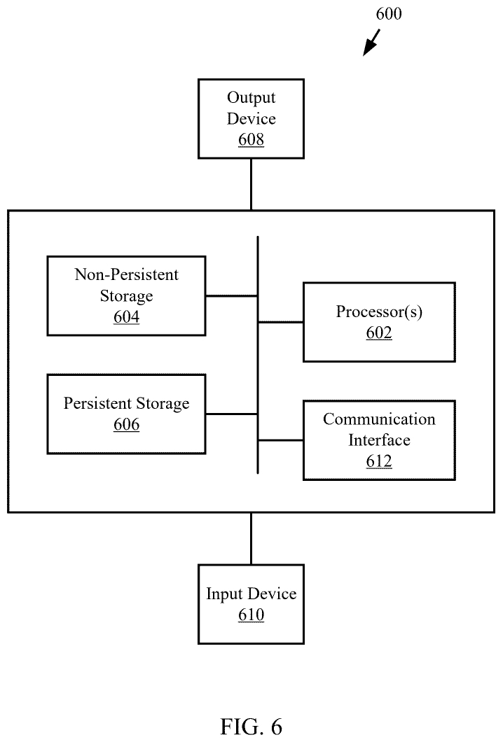

In one or more embodiments, the query device (100) may represent any physical computing system whereby one or more users may pose queries (also referred to herein as user inputs) and, subsequently, may receive resources (or information) best fit to address the queries. To that extent, the query device (100) may include functionality to: capture user inputs from users through speech and/or text; delegate the user inputs to the support system (110) for processing; receive resources (i.e., information through one or more forms or formats—e.g., text, images, speech, etc.) from the support system (110), which may address the user inputs and provide the received resources to the users. One of ordinary skill will appreciate that the query device (100) may perform other functionalities without departing from the scope of the disclosure. Examples of the query device (100) may include, but are not limited to, a desktop computer, a laptop computer, a tablet computer, a smartphone, a smart speaker, any other computing system similar to the exemplary computing system shown in FIG. 6, a telephone, or any other device capable of facilitating communication between a user and the support system (110).

While FIG. 1 shows a configuration of components, other system configurations may be used without departing from the scope of the disclosure. For example, in one embodiment, more than one query device (not shown) may operatively connect to the support system (110).

In one or more embodiments, the support system (110) is implemented using one or more computing devices (not shown), which may include computing servers. Each server may represent a physical server that may reside in a datacenter, or a virtual server that may reside in a cloud computing environment. Additionally or alternatively, the support system (110) may be implemented using one or more computing systems similar to the exemplary computing system shown in FIG. 6.

In one or more embodiments, the database (120) is used to store data that is used by the support system (110). In one or more embodiments, the database (120) stores information that a user wishes to interact with in some way through a machine learning model. In one or more embodiments, the database (120) stores data used by the support system (110) to perform actions in the building of a model, such as training, validating, calibrating, and/or testing.

In one or more embodiments, the database (120) is implemented using one or more computing devices. A computing device may be, for example, a mobile phone, tablet computer, laptop computer, desktop computer, server, distributed computing system, or a cloud resource. The computing device may include one or more processors, memory (e.g., random access memory), and persistent storage (e.g., disk drives, solid state drives, etc.). The database (120) may be implemented using other types of computing devices without departing from the embodiments disclosed herein. For additional details regarding computing devices, refer to FIG. 6. Further, in one or more embodiments, the database (120) is located on any combination of the query device (100), the support system (110), and any other location.

In one or more embodiments, the support system (110) and/or the database (120) are implemented using logical devices without departing from the embodiments disclosed herein. For example, the support system (110) and/or the database (120) may include virtual machines that utilize computing resources of any number of physical computing devices to provide the functionality of the support system (110) and/or the database (120). The support system (110) and/or the database (120) may be implemented using other types of logical devices without departing from the embodiments disclosed herein.

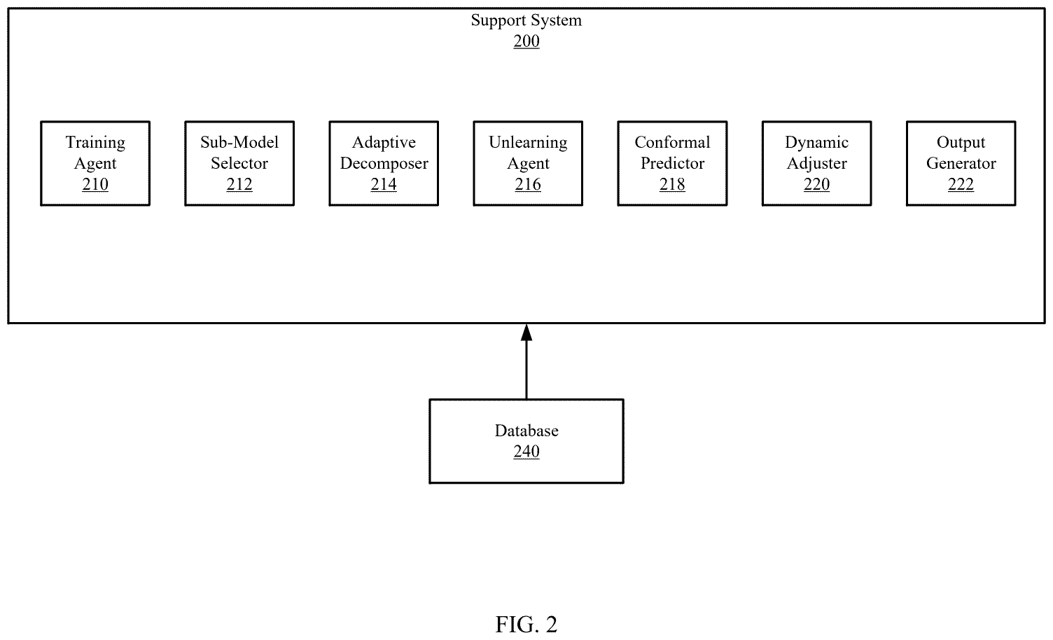

FIG. 2 shows a support system (200) (i.e., the support system (110) in FIG. 1) and a database (240) (i.e., the database (130) of FIG. 1) in accordance with one or more embodiments. The support system (200) includes a training agent (210), a sub-model selector (212), an adaptive decomposer (214), an unlearning agent (216), a conformal predictor (218), a dynamic adjuster (220), and an output generator (222). Each of these system components is described below.

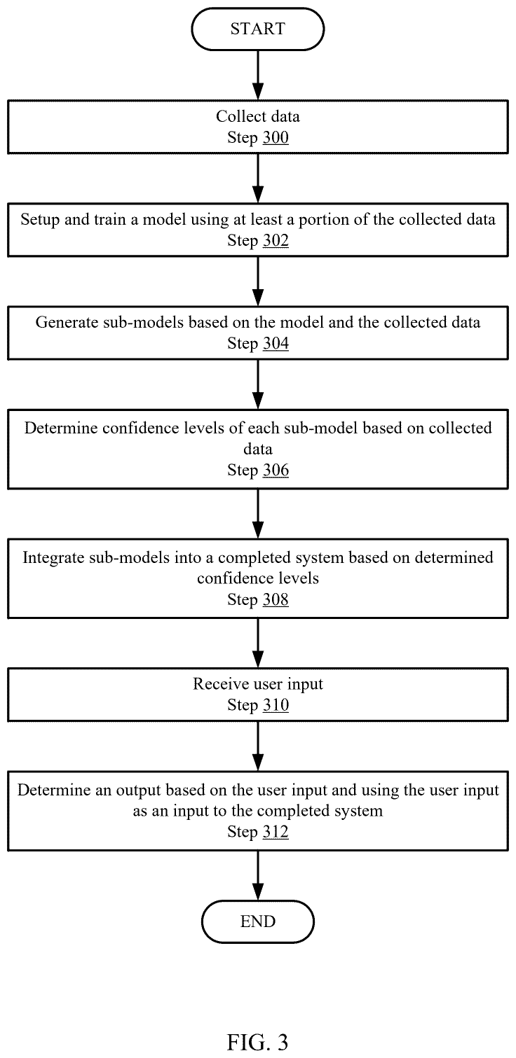

In one or more embodiments, one or more of the training agent (210), the sub-model selector (212), the adaptive decomposer (214), the unlearning agent (216), the conformal predictor (218), the dynamic adjuster (220), and the output generator (222) are implemented as a computing device (see e.g., FIG. 6). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the associated component described throughout this application and/or all, or a portion thereof, of the method illustrated in FIGS. 3-5.

In one or more embodiments, one or more of the training agent (210), the sub-model selector (212), the adaptive decomposer (214), the unlearning agent (216), the conformal predictor (218), the dynamic adjuster (220), and the output generator (222) are implemented as a logical device. The logical device may utilize the computing resources of the support system (200) and thereby provide the functionality of the associated component described throughout this application and/or all, or a portion thereof, of the method illustrated in FIGS. 3-5.

In one or more embodiments, the training agent (210) includes functionality to collect data and to train one or more machine learning models. In one or more embodiments, collecting data includes gathering, assessing, and preparing data for the training process.

In one or more embodiments, gathering first includes identifying relevant data sources. For example, for a company involved in customer services, these sources might include transaction records, customer interaction logs, service usage data, payment histories, and customer feedback. In another example, a financial services company might collect transaction data, customer demographics, account histories, and credit scores for building a model to predict creditworthiness. As can be seen, data sources can vary and are highly dependent on the use-case for the model. In one or more embodiments, after data sources are identified, the quality of the data is assessed. Assessing may include checking the data and/or data sources for accuracy, completeness, consistency, and relevance. In one or more embodiments, certain data may be removed from the data based on age of the data, relevance of the data, correctness of the data, and/or compliance with policies and/or regulations relating to the use of the data. Lack of data removal can lead to poor model performance. For example, a company using a model for financial services may ensure that the credit scores are up-to-date, transaction records are complete, that the data reflects the current financial behavior of customers, and that the intended use of the data complies with relevant policies and regulations.

In one or more embodiments, preparing the data includes cleaning and preprocessing the data, which includes handling missing values, correcting errors, and dealing with outliers. In one or more embodiments, data is also normalized or transformed prior to model training. For example, a company might standardize the format of dates in transaction records, fill in missing values in customer demographics, and normalize the scales of financial amounts. In one or more embodiments, for supervised learning models, data is labeled with the correct outputs for training purposes. For example, in the case of predicting creditworthiness, each customer's data would be labeled as ‘creditworthy’ or ‘not creditworthy’ based on the other data items associated with the customer.

In one or more embodiments, the training agent (210) also provides data storage and management for the data, which may include setting up databases or data warehouses with appropriate access controls. Further, data collection is an ongoing process that may occur continuously as new data becomes available or at discrete intervals, which may be considered to be in batches. In one or more embodiments, ongoing data collection increases the relevance of the data as conditions relating to the data change, such as customer behavior, market conditions, regulations, rights to use data, etc.

In one or more embodiments, training a model is the process where a machine learning algorithm learns from the data to make predictions or decisions. In one or more embodiments, training a model first includes selecting an appropriate machine learning algorithm or architecture based on the problem at hand. The machine learning models available could range from simple linear models to complex neural networks. For example, for a credit scoring system, a financial services company might choose a random forest algorithm due to its ability to handle a large number of input variables and provide insights into feature importance.

In one or more embodiments, after selecting a model, feature engineering tasks are performed, which includes creating new features from the existing data that may improve the model's performance. In one or more embodiments, feature engineering is a manual task or is an automated task that may be automated using other machine learning models. In general, feature engineering leverages domain knowledge to highlight important aspects of the data relating to the specific use-case of the model. For example, for a model that is used to predict creditworthiness of an individual, feature engineering could include creating new data such as debt-to-income ratio or number of late payments in the past year which may provide the model with more predictive power. In one or more embodiments, the training agent (210) is also responsible for collecting all of the data into a collected dataset.

In one or more embodiments, after performing the feature engineering tasks, the training agent (210) splits the collected dataset into different sets which may include any combination of a training dataset, a testing dataset, a validation dataset, and a calibration dataset. In one or more embodiments, the collected dataset is split so that other actions can be performed on the model with data that is statistically the same. In one or more embodiments, the collected dataset is split in such a way that most of the collected dataset is used for training purposes. For example, the collected dataset may be split into 70% for training, 10% for validation, 10% for calibration and 10% for testing.

In one or more embodiments, training the model includes training the selected model using the training dataset portion of the collected dataset. In one or more embodiments, during the training, the model learns the relationship between the features and the target variable. For example, the random forest algorithm would learn from the training data which factors are most indicative of a customer's creditworthiness.

Further, in one or more embodiments, training the model also includes adjusting certain aspects of the model, such as hyper parameters, which are the settings for the model that are not learned from the data but set before the training process. Tuning these parameters is essential for optimizing model performance. In one or more embodiments, training the model also includes performing validation techniques, such as cross-validation which includes dividing the training dataset into smaller parts and training the model multiple times, each time using a different part as a validation set. Cross-validation further includes, after training, the model's performance is evaluated using the test set and the validation set. Metrics such as accuracy, precision, recall, and the area under a receiver operating characteristic curve are used to assess how well the model is performing. In one or more embodiments, the model is adjusted based on the performance metrics of the model, which may include reiterating the feature engineering, changing the model architecture, and/or adjusting the hyper parameters. In one or more embodiments, after the model passes all of the testing and/or validation it is selected as the final model. This model may then be considered ready for deployment or further validation in a real-world setting.

In one or more embodiments, the sub-model selector (212) includes functionality to perform a conformal-based sub-model selection, which is a process of partitioning a trained model, such as the final model discussed above, into smaller, more manageable sub-models. In one or more embodiments, each sub-model is created to specialize based on the confidence of predictions each sub-model makes, which may be based on assigning a measure of confidence to the predictions made by each sub-model. For example, a credit scoring model could be split into three sub-models where the first one is specialized for consumers with a high credit score, a second one is specialized for consumers with a normal credit score, and a third one is specialized for consumers with a low credit score.

In one or more embodiments, conformal-based sub-model selection includes the following steps: data segmentation, sub-model creation, sub-model evaluation, integration of sub-models, conformal prediction adjustments, and a feedback loop for ongoing improvements. In one or more embodiments, the data used to train the original model is segmented into different subsets based on the confidence levels provided by conformal predictions and each subset corresponds to a different range of confidence levels. For example, the subsets could correspond to high, medium, and low confidence groups.

In one or more embodiments, for each data segment, a sub-model is created. Each sub-model is trained only on its respective data segment. In one or more embodiments, the training agent (210) is also responsible for training each sub-model, and each sub-model may be trained in the same manner as training a model is described above. In one or more embodiments, training each sub-model on only a portion of the overall training dataset enables each sub-model to become specialized in making predictions for data points within its confidence range. For example, separate sub-models could be created for high, medium, and low confidence customer segments, with each model being an expert in its segment. In one or more embodiments, use of conformal prediction provides a measure of the reliability of each sub-model's predictions by determining prediction intervals above a threshold coverage probability. In one or more embodiments, the prediction interval of a potential sub-model is based on the non-conformity score of an instance in the calibration set and a predefined significance level. Further, selecting a potential sub-model may be based on identifying the sub-model with the narrowest prediction interval that satisfies an empirical coverage constraint, which may be the proportion of actual outcomes that fall within the interval using a calibration dataset. In one or more embodiments, optimizing the sub-models based on empirical coverage provides a practical and robust measure of the sub-models performance. Further, use of conformal predictions for sub-models provides, in addition to accuracy, a quantifiable measure of uncertainty in the sub-model's predictions.

In one or more embodiments, sub-model evaluation includes assessing the model's accuracy, precision, and other relevant metrics on a validation dataset. For example, the high confidence sub-model would be evaluated based on its ability to identify customers who are very likely to be creditworthy.

In one or more embodiments, integrating the sub-models includes integrating all of the selected sub-models into a cohesive, or completed, system. In the completed system, when a user provide an input, a first layer of the system determines which sub-model(s) should be utilized to make a prediction based on the input. As discussed above, each sub-model may be specialized for certain subsets of data. For example, when a new customer's data is input into a completed model that predicts creditworthiness, the completed system first determines which sub-model's confidence range the customer's data falls into and uses the appropriate sub-model to predict their creditworthiness.

In one or more embodiments, conformal prediction adjustments includes adjusting the selected sub-models based on their performance on a validation dataset. Doing so may enhance the reliability of the confidence levels of each sub-model. For example, if a medium confidence sub-model is found to be too conservative, its confidence thresholds might be adjusted to better reflect its actual predictive capabilities.

In one or more embodiments, the feedback loop includes monitoring (e.g., continuously or at discrete intervals) each of the sub-models as they encounter new data inputs. In one or more embodiments, the conformal prediction threshold are adjusted based on the new data inputs, as new collected data becomes available, or a combination thereof, to enable each sub-model to evolve and adapt to new data over time.

In one or more embodiments, the adaptive decomposer (214) includes functionality provide adaptive decomposition to dynamically restructure one or more sub-models, which may optimize its performance and/or maintain or increase its accuracy over time. In one or more embodiments, the adaptive decomposition includes one or more of the following steps: performance monitoring, identification of drift and/or shift, adaptive adjustments, decomposition, data re-segmentation, sub-model merging or splitting, reevaluation and integration, and a feedback loop.

In one or more embodiments, performance monitoring includes tracking (i.e., continuously or at discrete intervals) how well each sub-model predicts new data being fed into the sub-model and whether its confidence intervals remain accurate. For example, for a model that predicts creditworthiness, each sub-model's predictions on new loan applications are monitored to determine whether the actual outcomes (e.g., loan repayment or default) align with the predictions.

In one or more embodiments, identification of drift and/or shift includes monitoring the underlying data distribution for changes, which is known as drift or shift. In one or more embodiments, the underlying data distribution can change due to external factors, such as customer behavior, economic factors, regulations, etc. For example, an economic downturn may cause lenders to be more reluctant to provide loans, the ability of customers to repay loans, etc.

In one or more embodiments, adaptive adjustments includes determining that the monitoring and/or identification of drift and/or shift described above has exceeded a threshold, which may indicate that the relevant sub-model's accuracy is declining or that its confidence intervals are no longer properly calibrated. In one or more embodiments, the adaptive adjustment also include, based on the determination, retraining the sub-model, adjusting the hyper parameters of the sub-model, and/or recalibrating its confidence intervals. For example, a sub-model may be retrained with more recent data and/or its confidence thresholds may be adjusted to reflect the new data distribution.

In one or more embodiments, decomposition is an adaptive strategy that changes over time based on the characteristics of the data and/or the performance of the sub-model, which may increase the accuracy and efficiency of the sub-model. In one or more embodiments, the decomposition includes receiving a model and decomposing the model into multiple sub-models, and then training each sub-model on a different portion of the underlying training dataset. In one or more embodiments, the number of sub-models chosen is based on clustering techniques, dimensionality reduction, or any other method used to identify subdivisions within a dataset.

In one or more embodiments, data re-segmentation includes determining that the drift and/or shift exceeds a threshold and re-aligning the boundaries for which data goes to which sub-model as an input. For example, the boundaries defining high, medium, and low confidence customer segments in a credit scoring system may be moved to account for new patterns in the underlying customer data.

In one or more embodiments, the sub-model merging or splitting includes determining that a threshold change in similarity of the underlying dataset for a sub-model has exceeded a threshold. In one or more embodiments, if the datasets of two different sub-models become too similar, the two different sub-models may be merged into a single sub-model. In one or more embodiments, if the dataset of a single sub-model has become too diverse, the single sub-model may be split into multiple sub-models.

In one or more embodiments, reevaluation includes reevaluating a sub-model after any changes described above have been made in the same manner as discussed above. In one or more embodiments, after the sub-model has been reevaluated and found to be in conformance with the applied standards, the sub-model is reintegrated into the completed system. In one or more embodiments, reintegrating the sub-model into the completed system may also include adjusting the completed system, such as by adjusting how the completed system determines which sub-model to utilize when receiving a new user input.

In one or more embodiments, the feedback loop includes monitoring (e.g., continuously or at discrete intervals) each of the sub-models as they encounter new data inputs. In one or more embodiments, the conformal prediction threshold is adjusted based on the new data inputs, as new collected data becomes available, or a combination thereof, to enable each sub-model to evolve and adapt to new data over time.

In one or more embodiments, the unlearning agent (216) includes functionality to unlearn by selectively remove data from a machine learning model, such as the completed model or a sub-model. In one or more embodiments, unlearning includes one or more of the following steps: identification of data for removal, identification of the affected sub-model, data exclusion, model reevaluation, conformal prediction recalibration, and system integration.

In one or more embodiments, identification of the data for removal includes receiving a user request, identifying an error in the data, identifying data that is too old, and/or identifying data that is not in compliance with a regulation. For example, certain regulations may provide a right for a consumer to be forgotten, which may be exercised by a consumer. In such an example, the data associated with the consumer as defined under the controlling regulation is identified for removal.

In one or more embodiments, identifying the sub-model includes using the identified data to identify any model and/or sub-model that is associated with the identified data. For example, if only one sub-model of a completed model was trained using the identified data, then only the one sub-model is identified as being associated with the identified data.

In one or more embodiments, data exclusion includes a process for removing the influence the identified data had on the identified model. In one or more embodiments, this process includes techniques such as data carving in which a model is adjusted without a full retraining, subtractive training in which a model is updated to forget data, or fully retraining the sub-model with the identified data removed from the training dataset.

In one or more embodiments, reevaluation includes reevaluating the identified sub-model after the data exclusion process described above has been made and the reevaluating may be performed in the same manner as discussed above.

In one or more embodiments, conformal prediction recalibration includes updating the prediction intervals of any updated sub-models to reflect any changes made during the data exclusion process. In one or more embodiments, after the updated sub-model has been reevaluated and recalibrated and found to be in conformance with the applied standards, the sub-model is reintegrated into the completed system.

In one or more embodiments, the conformal predictor (218) includes functionality to provide conformal prediction integration after unlearning to ensure that the completed system maintains its reliability and statistically valid measures of uncertainty. In one or more embodiments, conformal prediction integration includes one or more of the following steps: reestablishing prediction confidence, calibrating conformal predictors, validating against new data, integration, providing outputs, and a feedback loop.

In one or more embodiments, reestablishing prediction confidence includes reestablishing the confidence levels of the model after the data has been unlearned, which may be performed using the conformal prediction methods discussed above. In one or more embodiments, calibrating conformal predictors includes calibrating using the data remaining after unlearning, which may include determining the appropriate nonconformity measures and significance levels that define the prediction intervals. For example, the calibration might involve adjusting the nonconformity scores based on the distribution of the remaining customer data.

In one or more embodiments, validating against new data includes validating the calibrated conformal predictors against a validation dataset. The validation may also include determining that the calibrated conformal predictors performed above a threshold level of performance. For example, the recalibrated credit scoring model is tested with new loan applications to verify that the conformal prediction intervals are correctly estimating the likelihood of repayment or default.

In one or more embodiments, after the updated sub-model has been recalibrated and validated and found to be in conformance with the applied standards, the sub-model is reintegrated into the completed system. In one or more embodiments, providing outputs includes translating statistical confidence measures into more understandable terms or visualizations. For example, the credit scoring system might display a confidence interval as a simple percentage chance of the credit score being accurate, or use traffic light colors to indicate the level of confidence (green for high, yellow for medium, red for low).

In one or more embodiments, the feedback loop includes monitoring (e.g., continuously or at discrete intervals) the conformal predictors as they encounter new data inputs. In one or more embodiments, the conformal predictors are adjusted based on the new data inputs, as new collected data becomes available, or a combination thereof, to enable each sub-model to evolve and adapt to new data over time.

In one or more embodiments, the dynamic adjuster (220) includes functionality to provide dynamic adjustment by including real-time monitoring and updating of the model to adapt to new data or changes in the underlying data distribution. In one or more embodiments, dynamic adjustment includes one or more of the following steps: real-time monitoring, identifying triggering conditions, data analysis, model updating, recalibration, integration and deployment, and a feedback loop.

In one or more embodiments, the real-time monitoring includes continuously monitoring the model's predictions and the actual outcomes. Further, discrepancies between the predictions and the actual outcomes are identified, which may be indicative of a shift in the data or a degradation of the model's performance. For example, in a model predicting creditworthiness, the model's predictions of creditworthiness are compared against actual loan repayment behaviors, and, if a discrepancy above a threshold is noted, such as an increase in defaults not predicted by the model, a review is triggered.

In one or more embodiments, identifying triggering condition includes identifying the occurrence of specific conditions, which may include statistical thresholds, such as a certain percentage of mispredictions, or based on a certain amount of time having passed since the last review.

In one or more embodiments, data analysis includes a thorough analysis of recent data, which includes identifying any new patterns in the new data or changes in data distribution, such as drift, which is discussed above. In one or more embodiments, the model updating includes any form of model updating, such as retraining the model with new data, fine-tuning model parameters, or even restructuring the model if significant changes in the data are detected. For example, the credit scoring model is updated with new data reflecting the current economic conditions, and parameters are adjusted to better capture the risk associated with these changes. In one or more embodiments, recalibration, integration, deployment, and the feedback loop may be performed in the same manner as discussed above.

In one or more embodiments, the output generator (222) includes functionality to provide an understandable output to a user, which includes translating the raw output of the model into an actionable insight or decision. In one or more embodiments, providing the understandable output include one or more of the following steps: aggregation of sub-model predictions, application of conformal prediction, decision rule application, and formatting the output.

In one or more embodiments, aggregating the sub-model predictions includes receiving output from multiple sub-models and aggregating them into a single output. For example, an industrial machine prediction model may use multiple sub-models to make predictions about different aspects of the machinery, such as temperature anomalies, vibration levels, or unusual sounds. The final output is an aggregated result of these sub-models.

In one or more embodiments, application of conformal prediction includes providing a measure of certainty of the final output which may include applying the conformal prediction techniques discuss above to provide a prediction interval or a likelihood that the final output is correct. For example, the industrial machine prediction model's final output could be a prediction that a machine has a 75% chance of failure in the next two days, but the prediction interval is 70% to 80%.

In one or more embodiments, decision rule application includes identifying a relevant rule related to the final output and determining whether the output and/or the conformal predictors implicate the relevant rule, which may be a threshold value. For example, a rule may be to provide an alert if the final output indicates a machine is more than 70% likely to fail within the next two days.

In one or more embodiments, formatting the output includes receiving the final output, the conformal predictors, and the decision rule application and providing a human-readable output to a user, which may include providing the human-readable output via an interface as described below. For example, the industrial machine prediction model's final output is a prediction that a machine has a 75% chance of failure in the next two days, the prediction interval is 70% to 80%, and the rule is to provide an alert if the final output indicates a machine is more than 70% likely to fail within the next two days, then the human-readable output may include an alert icon that indicates that the machine is likely to fail within the next two days and immediate action should be taken. The more detailed information may also be available to the user upon further interaction by the user.

Turning to FIG. 3, FIG. 3 shows a flowchart describing a method for generating sub-models and providing outputs via the sub-models based on user inputs in accordance with one or more embodiments disclosed herein. The method may be performed by, for example, the support system (e.g., 200, FIG. 2).

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In Step 300, the support system collects data. The collection or gathering of data may be performed by the training agent (e.g., 210, FIG. 2), the details of which are discussed above.

In Step 302, the support system sets up and trains a model using at least a portion of the collected data. The setting up and training of the model may be performed by the training agent, the details of which are discussed above.

In Step 304, the support system generates sub-models based on the model and the collected data. The generating of the sub-models may be performed by the sub-model selector (e.g., 212, FIG. 2), the details of which are discussed above.

In Step 306, the support system determines confidence levels of each sub-model based on collected data. The determining of confidence levels may be performed by the sub-model selector, the details of which are discussed above.

In Step 308, the support system integrates the sub-models into a completed system based on determined confidence levels. The integrating of the sub-models may be performed by the sub-model selector, the details of which are discussed above. In one or more embodiments, the integration of the sub-models forms a completed system, capable of receiving user inputs and providing outputs based on the user inputs.

In Step 310, the support system receives a user input. The user input may be received by the support system via the query device (e.g., 100, FIG. 1), the details of which are discussed above.

In Step 312, the support system determines an output based on the user input and using the user input as an input to the completed system. The determination of the output may be performed by the completed system as discussed above, and the presentation of the output to the user may be performed by the output generator (e.g., 222, FIG. 2), the details of which are discussed above.

In one or more embodiments, the method may end following Step 312.

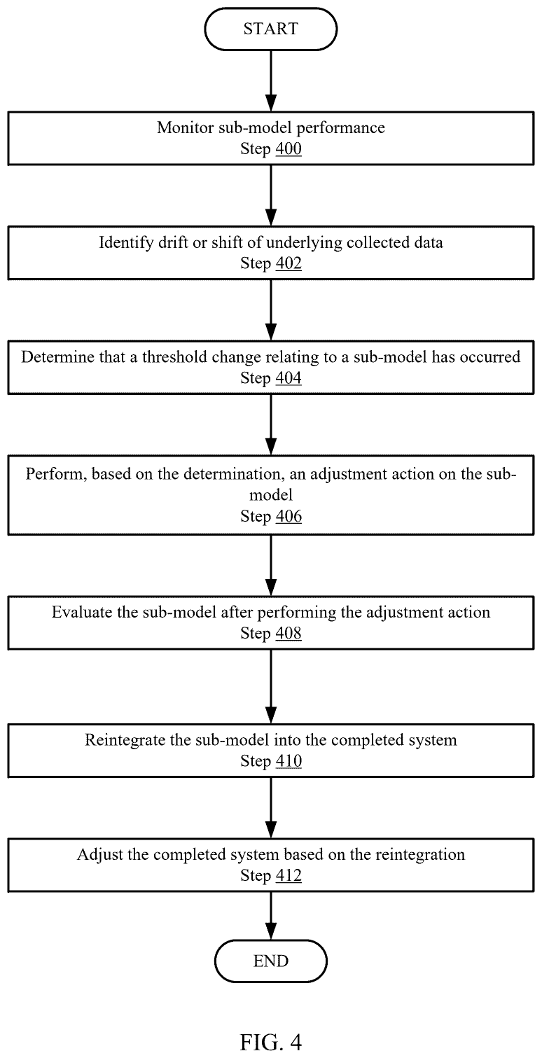

Turning to FIG. 4, FIG. 4 shows a flowchart describing a method for monitoring and adjusting the sub-models over time in accordance with one or more embodiments disclosed herein. The method may be performed by, for example, the support system (e.g., 200, FIG. 2).

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In Step 400, the support system monitors the sub-model's performance over time. As discussed above, a completed system may include a number of sub-models, each of which may be monitored. The monitoring may be performed by any combination of the sub-model selector (e.g., 212, FIG. 2), the adaptive decomposer (e.g., 214, FIG. 2), the unlearning agent (e.g., 216, FIG. 2), the conformal predictor (e.g., 218, FIG. 2), and the dynamic adjuster (e.g., 220, FIG. 2), the details of which are discussed above.

In Step 402, the support system identifies drift or shift of the underlying collected data that was used to train the sub-model being monitored. The identifying of shift or drift may be performed by the adaptive decomposer and/or the dynamic adjuster, the details of which are discussed above.

In Step 404, the support system determines that a threshold change relating to a sub-model has occurred. The determining of the threshold change and the types of threshold changes may be performed by the adaptive decomposer and/or the dynamic adjuster, the details of which are discussed above.

In Step 406, the support system performs, based on the determination, an adjustment action on the sub-model. In one or more embodiments, the adjustment action includes any combination of the following: resegmenting a data set associated with the sub-model, merging the sub-model with another sub-model, splitting the sub-model into two sub-models, retraining the sub-model, adjusting the conformal predictors associated with the sub-model, updating a model parameter of the sub-model, and restructuring a structure of the sub-model. The adjustment action may be performed by any combination of the sub-model selector, the adaptive decomposer, the unlearning agent, the conformal predictor, and the dynamic adjuster, the details of which are discussed above.

In Step 408, the support system evaluates or reevaluates the sub-model after performing the adjustment action. The evaluating of the sub-models may be performed by the adaptive decomposer and/or the unlearning agent, the details of which are discussed above.

In Step 410, the support system reintegrates the sub-model into the completed system. The reintegration may be performed by any combination of the adaptive decomposer, the unlearning agent, and the conformal predictor, the details of which are discussed above.

In Step 412, the support system adjusts the completed system based on the reintegration. The adjustment may be performed by the adaptive decomposer, the details of which are discussed above.

In one or more embodiments, the method may end following Step 412.

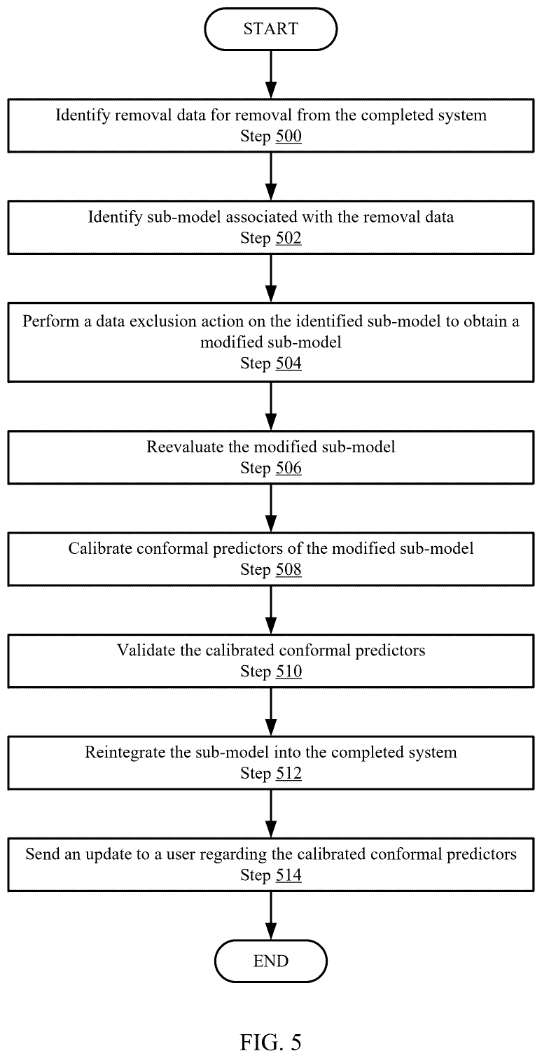

Turning to FIG. 5, FIG. 5 shows a flowchart describing a method for removing data from a model via unlearning in accordance with one or more embodiments disclosed herein. The method may be performed by, for example, the support system (e.g., 200, FIG. 2).

While the various steps in the flowchart shown in FIG. 5 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In Step 500, the support system identifies removal data for removal from the completed system. The identification may be performed by the unlearning agent (e.g., 216, FIG. 2), the details of which are discussed above.

In Step 502, the support system identifies a sub-model associated with the removal data. The identification may be performed by the unlearning agent, the details of which are discussed above.

In Step 504, the support system performs a data exclusion action on the identified sub-model to obtain a modified sub-model. The data exclusion action may be performed by the unlearning agent, the details of which are discussed above.

In Step 506, the support system reevaluates the modified sub-model after performing the data exclusion action. The reevaluating of the modified sub-model may be performed by the adaptive decomposer (e.g., 214, FIG. 2) and/or the unlearning agent, the details of which are discussed above.

In Step 508, the support system calibrates conformal predictors of the modified sub-model. The calibration of the modified sub-model may be performed by the adaptive decomposer, the unlearning agent, or the conformal predictor, the details of which are discussed above.

In Step 510, the support system validates the calibrated conformal predictors. The validation may be performed by the conformal predictor, the details of which are discussed above.

In Step 512, the support system reintegrates the sub-model into the completed system. The reintegration may be performed by any combination of the adaptive decomposer, the unlearning agent, and the conformal predictor, the details of which are discussed above.

In Step 514, the support system sends an update to the user regarding the calibrated conformal predictors. In one or more embodiments, the support system provides update information to the user whenever a change is made and completed to the model and includes the details of the changes made to the model, such as the updated calibrated conformal predictors.

In one or more embodiments, the method may end following Step 514.

As discussed above, embodiments of the disclosure may be implemented using computing devices. FIG. 6 shows a diagram of a computing device (600) in accordance with one or more embodiments. The computing device (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), input devices (610), output devices (608), and numerous other elements (not shown) and functionalities. Each of these components is described below.

In one embodiment, the computer processor(s) (602) may be an integrated circuit for processing instructions. For example, the computer processor(s) (602) may be one or more cores or micro-cores of a processor. The computing device (600) may also include one or more input devices (610), such as a touchscreen, keyboard, mouse, microphone, touchpad, electronic pen, or any other type of input device. The communication interface (612) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment, the computing device (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (608, 610) may be locally or remotely connected to the computer processor(s) (602), non-persistent storage (604), and persistent storage (606). Many diverse types of computing devices exist, and the aforementioned input and output device(s) (608, 610) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for removing data from a model, the method comprising:
identifying removal data for removal from the model, wherein the model comprises a plurality of sub-models;
identifying a sub-model from the plurality of sub-models associated with the removal data, wherein the sub-model comprises a plurality of conformal predictors;
performing a data exclusion action on the sub-model to obtain a modified sub-model;
making a determination that the modified sub-model is above a threshold accuracy based on a reevaluation using a first validation data set;
calibrating, based on the determination, the plurality of conformal predictors of the modified sub-model to obtain calibrated conformal predictors;
validating the calibrated conformal predictors using a second validation data set; and
reintegrating, based on the validating, the modified sub-model into the model.

2. The method of claim 1, wherein the method further comprises:
monitoring a performance of the modified sub-model;
making a first determination, based on the monitoring, that a threshold change relating to the modified sub-model has occurred;
performing, in response to the first determination, an adjustment action on the modified sub-model to obtain a second modified sub-model; and
reintegrating, after performing the adjustment action, the second modified sub-model into the model.

3. The method of claim 2, wherein performing the adjustment action comprises an adaptive decomposition action, wherein the adaptive decomposition action comprises at least one of the following: resegmenting a data set associated with the modified sub-model, merging the modified sub-model with a second sub-model of the plurality of sub-models, and splitting the modified sub-model into a first modified sub-model and a second modified sub-model.

4. The method of claim 2, wherein the adjustment action comprises at least one of the following: retraining the modified sub-model, adjusting the plurality of conformal predictors, updating a model parameter of the modified sub-model, and restructuring a structure of the modified sub-model.

5. The method of claim 1, wherein identifying removal data is based on at least one of the following: receiving a user request to remove the removal data from the model, determining that the removal data is associated with an error, determining that the removal data is stale, and determining that use of the removal data in the model is not in compliance with a regulation.

6. The method of claim 1, wherein the plurality of conformal predictors comprises a nonconformity measure and a significance level.

7. The method of claim 6, wherein calibrating comprises adjusting the nonconformity measure.

8. The method of claim 1, wherein the data exclusion action comprises data carving or subtractive training.

9. The method of claim 1, wherein the method further comprises:
receiving a user input for the model;
determining that the modified sub-model is a best match of the plurality of sub-models for the user input;
determining, using the user input as an input into the modified sub-model, an output, wherein the output comprises a prediction based on the user input and a confidence interval for the prediction; and
sending the output to a user.

10. A method for removing data from a model, the method comprising:
identifying removal data for removal from the model wherein the model comprises a plurality of conformal predictors;
performing a data exclusion action on the model to obtain a modified model;
making a determination that the modified model is above a threshold accuracy based on a reevaluation using a first validation data set;
calibrating, based on the determination, the plurality of conformal predictors of the modified model to obtain calibrated conformal predictors; and
validating the calibrated conformal predictors using a second validation data set.

11. The method of claim 10, wherein the method further comprises:
monitoring a performance of the modified model;
making a first determination, based on the monitoring, that a threshold change relating to the modified model has occurred; and
performing, in response to the first determination, an adjustment action on the modified model to obtain a second modified model.

12. The method of claim 11, wherein performing the adjustment action comprises an adaptive decomposition action, wherein the adaptive decomposition action comprises at least one of the following: resegmenting a data set associated with the modified model, merging the modified model with a second model, and splitting the modified model into a first modified sub-model and a second modified sub-model.

13. The method of claim 11, wherein the adjustment action comprises at least one of the following: retraining the modified model, adjusting the plurality of conformal predictors, updating a model parameter of the modified model, and restructuring a structure of the modified model.

14. The method of claim 10, wherein identifying removal data is based on at least one of the following: receiving a user request to remove the removal data from the model, determining that the removal data is associated with an error, determining that the removal data is stale, and determining that use of the removal data in the model is not in compliance with a regulation.

15. The method of claim 10, wherein the plurality of conformal predictors comprises a nonconformity measure and a significance level.

16. The method of claim 15, wherein calibrating comprises adjusting the nonconformity measure.

17. The method of claim 10, wherein the data exclusion action comprises data carving or subtractive training.

18. A method for removing data from a model, the method comprising:
identifying removal data for removal from the model, wherein the model comprises a plurality of sub-models;
identifying a sub-model from the plurality of sub-models associated with the removal data, wherein the sub-model comprises a plurality of conformal predictors;
performing a data exclusion action on the sub-model to obtain a modified sub-model;
making a determination that the modified sub-model is above a threshold accuracy based on a reevaluation using a first validation data set;
calibrating, based on the determination, the plurality of conformal predictors of the modified sub-model to obtain calibrated conformal predictors;
validating the calibrated conformal predictors using a second validation data set;
reintegrating, based on the validating, the modified sub-model into the model;
monitoring a performance of the modified sub-model;
making a first determination, based on the monitoring, that a threshold change relating to the modified sub-model has occurred;
performing, in response to the first determination, an adjustment action on the modified sub-model to obtain a second modified sub-model;
reintegrating, after performing the adjustment action, the second modified sub-model into the model;
after the reintegrating:
receiving a user input for the model;
determining that the modified sub-model is a best match of the plurality of sub-models for the user input;
determining, using the user input as an input into the modified sub-model, an output, wherein the output comprises a prediction based on the user input and a confidence interval for the prediction; and
sending the output to a user.

19. The method of claim 18, wherein performing the adjustment action comprises an adaptive decomposition action, wherein the adaptive decomposition action comprises at least one of the following: resegmenting a data set associated with the modified sub-model, merging the modified sub-model with a second sub-model of the plurality of sub-models, and splitting the modified sub-model into a first modified sub-model and a second modified sub-model.

20. The method of claim 18, wherein the adjustment action comprises at least one of the following: retraining the modified sub-model, adjusting the plurality of conformal predictors, updating a model parameter of the modified sub-model, and restructuring a structure of the modified sub-model.
